(19) United States
(12) Patent Application Publication
(10) Pub. No.: US 2025/0110394 A1
(43) Pub. Date: Apr. 3, 2025

(54) ADJUSTABLE DEVICE PROJECTION SYSTEM

(71) Applicant: CRAYOLA LLC, EASTON, PA (US)

(72) Inventors: ROBERT HENRY, BETHLEHEM, PA (US); GREGORY NUNGESTER, MILFORD, NJ (US); YING K. HO, BETHLEHEM, PA (US); LINDSEY CUOMO, EMMAUS, PA (US)

(73) Assignee: CRAYOLA LLC, EASTON, PA (US)

(21) Appl. No.: 18/899,672

(22) Filed: Sep. 27, 2024

Related U.S. Application Data
(60) Provisional application No. 63/586,709, filed on Sep. 29, 2023.

(51) Int. Cl. G03B 21/14; G06F 1/16; H04M 1/04

(52) U.S. Cl. CPC G03B 21/145; G06F 1/166; H04M 1/04; H04M 2250/54

(57) ABSTRACT

An adjustable device projection system includes a main housing, a base, and a device holder. The main housing has a lens defining a focal axis. The base is coupled to and extends from the main housing. The device holder is coupled to the base and is configured to hold a mobile device generally in optical alignment with the at least one lens. The system may include an adjuster to adjust the mobile device relative to the lens or adjust an orientation of the focal axis. The adjuster may include a track along which the device holder adjustably slides. The adjuster may include a support configured to adjust an orientation of the focal axis. A kit including the adjustable device projection system and a light board system configured to display images projected via the projection system.

### CROSS-REFERENCE TO RELATED APPLICATIONS

This application is based on and claims priority to U.S. Provisional Application Ser. No. 63/586,709, filed on Sep. 29, 2023, which is incorporated herein by reference in its entirety.

### BACKGROUND

Projection systems may be used to transmit images from a source to a designated display surface, such as a screen or a wall. Typical projection systems can be used for numerous purposes, including for displaying videos, portions of videos, or still images on a designated surface for large-scale viewing and projecting an art image onto a designated surface so a larger version of the art image can be drawn or traced over the image displayed on the designated surface. These projection systems typically use optical elements such as refractive lenses or panes to direct an original image to such a designated surface.

Some projection systems are adapted for use with general-purpose digital display devices, such as mobile phones or tablets, and rely on specifically configured optical elements, such as Fresnel lenses, which are adapted to produce magnified images of specific device displays with particular geometries and dimensions. While these display device projection systems can be used to transmit videos and images from a specific device to a designated surface, they typically rely on device-specific components that are not broadly adjustable for use with multiple different devices, such as a mobile device and a tablet that have different display sizes and aspect ratios. Additionally, device-specific components such as the above-described Fresnel lenses can be expensive and difficult to replace. Moreover, specialized display device projection systems can have large, cumbersome, or fragile components.

### SUMMARY

An adjustable device projection system in accordance with one exemplary aspect of the invention described herein includes a main housing, a base, a device holder, and an adjuster. The main housing has at least one lens that defines a focal axis. The base is coupled to the main housing and extends from the main housing. The device holder is coupled to the base and is configured to hold at least one of a mobile phone or a tablet generally in optical alignment with the at least one lens. The adjuster includes at least one of: a track that extends along the base, or a support. The device holder is configured to slidably engage the track such that a position of the device holder is adjustable relative to the at least one lens in a direction generally aligned with the focal axis. The support is configured to adjust an orientation of the focal axis.

In some embodiments, the main housing has a main housing body and a lens holder in which at least one lens is held. The lens holder can be adjustable between a retracted configuration and an extended configuration relative to the main housing body. In other embodiments, the device holder is slidable on the track between a first position and a second position, wherein the device holder is closer to the at least one lens in the second position than in the first position. In other embodiments, the base is pivotably coupled to the main housing, and the main housing is movable relative to the base between a plurality of designated projection orientations. In further embodiments, the plurality of projection orientations can include a substantially horizontal projection orientation in which the main housing is substantially perpendicular to the base and an intermediate projection orientation in which an acute angle is defined between the main housing and the base. In other embodiments, the support comprises a main housing support that can selectively support the main housing in the plurality of designated projection orientations, e.g., by releasably engaging the base. In yet further embodiments, the main housing support is configured to collapse relative to the main housing when the main housing is placed in a collapsed orientation relative to the base where the main housing is substantially parallel to the base.

In yet other embodiments, the support comprises a stand coupled to the base, wherein the stand is movable between at least a first position, in which the base is oriented at a first angle relative to a support surface on which the base is placed, and a second position, in which the base is oriented at a second angle relative to the support surface, and where the second angle is greater than the first angle. In additional embodiments, the device holder is configured to hold both a mobile phone and a tablet, where the tablet has a display screen with a surface area at least twice the size of a surface area of a phone display screen of the mobile phone. The device holder can be configured to hold both the mobile phone and the tablet in a substantially vertical display orientation and a substantially horizontal display orientation. In other embodiments, the main housing can have an adjustable foot configured to manipulate an elevation of the at least one lens relative to a support surface on which the base is placed.

In further embodiments, a tracing kit for mobile devices can include the device projection system and a light board system that is adapted for displaying an image generated by a display device held by the holder. The light board system includes a light-transmissive drawing surface through which the image can be transmitted, and the light board system and the device projection system can be positioned independently relative to each other to manipulate the image projected to the light board by the device projection system.

An adjustable device projection system in accordance with another exemplary aspect of the invention herein includes: a main housing with at least one lens defining a focal axis and a lens holder configured to hold the at least one lens; and a base coupled to the main housing. The base includes a device holder configured to hold at least one of a mobile phone or a tablet such that a display of the at least one of a mobile phone or a tablet is generally in optical alignment with the at least one lens. The device holder is configured to be selectively positioned on the base relative to the at least one lens in a direction generally aligned with the focal axis. The lens holder is configured to be adjustably positioned within the main housing to selectively adjust a focus of the at least one lens when an image is transmitted from the display of the device held by the device holder. In further embodiments, the device holder and the lens holder can be independently adjusted. In additional embodiments, the main housing is pivotably coupled to the base, and the main housing is movable relative to the base between a collapsed orientation and at least one designated projection orientation for projecting the image transmitted from the display of the device held by the device holder.

A tracing kit in accordance with yet another exemplary aspect of the invention described herein includes a device projection system and a light board system. The device projection system includes at least one lens and a device holder. The device holder is configured to hold at least one of a mobile phone or a tablet generally in optical alignment with the at least one lens. The device projection system is configured to transmit an image generated by a display of a device held by the holder through the at least one lens. The light board system includes a light-transmissive drawing surface through which an image from the device projection system can be transmitted. In further embodiments, the light board system and the device projection system can be positioned independently relative to each other to manipulate the image projected to the light board system from the device projection system. In other embodiments, the device projection system holds the at least one lens in a selectively adjustable configuration so that a focus of the at least one lens can be selectively adjusted. In yet other embodiments, the light board system has a diffusive panel positioned between the drawing surface and the at least one lens in the device projection system. The light board system can further have a backlight configured to illuminate a region between the drawing surface and the diffusive panel.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of an adjustable device projection system in accordance with an exemplary embodiment of the invention described herein in the light board projection configuration, with the lens housing in an extended position and the device holder in a rearward position;

FIG. 2 is a side elevation view of the system shown in FIG. 1;

FIG. 3 is a bottom view thereof;

FIG. 4 is a front elevation view thereof;

FIG. 5 is a rear elevation view thereof;

FIG. 6 is a cross-section taken through the line 6-6 of FIG. 4;

FIG. 7 is a cross-section of the system shown in FIG. 6 in a wall projection configuration;

FIG. 8 is a cross-section of the system shown in FIG. 6 in a collapsed configuration;

FIG. 9 is a perspective view of a base of the system shown in FIG. 1;

FIG. 10 is a perspective view of a main housing support of the system shown in FIG. 1;

FIG. 11 is a perspective view of a main housing body of the system shown in FIG. 1;

FIG. 12 is a rear elevation view of the main housing body of FIG. 11;

FIG. 13 is a perspective view of the lens housing of the system shown in FIG. 1;

FIG. 14 is a perspective view of the device holder and device holder mount of the system shown in FIG. 1;

FIG. 15 is a perspective view of the light board assembly used with the system shown in FIG. 1 in a kit in accordance with an exemplary embodiment of the invention described herein;

FIG. 16 is a rear perspective view of the light board assembly shown in FIG. 15;

FIG. 17 is a perspective view of a kit including the system shown in FIG. 1 and the light board assembly shown in FIG. 15, a tablet in a portrait orientation, and an image projected from the tablet to the light board assembly;

FIG. 18 is a side elevation view of the kit shown in FIG. 17;

FIG. 19 is a perspective view of the kit shown in FIG. 17 with the tablet in a landscape orientation;

FIG. 20 is a perspective view of the system shown in FIG. 1, a drawing sheet mounted on a wall, the tablet shown in FIG. 17, and an image projected onto the drawing sheet;

FIG. 21 is a perspective view of the kit shown in FIG. 17 with a mobile phone in a portrait orientation and an image projected from the mobile phone to the light board assembly;

FIG. 22 is a perspective view of an alternative adjustable device projection system in accordance with an exemplary embodiment of the invention described herein, with its foot and leg in their stowed configurations;

FIG. 23 is a lower perspective view of the system shown in FIG. 22; and

FIG. 24 is a lower perspective view of the system shown in FIG. 23 with the foot and leg in their extended configurations.

### DETAILED DESCRIPTION OF EXEMPLARY EMBODIMENTS

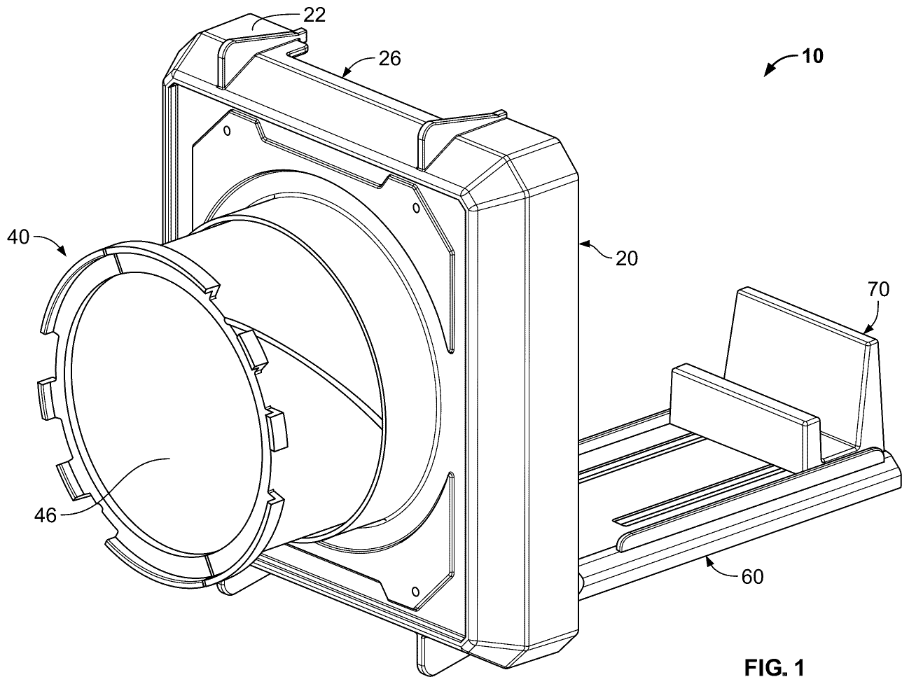

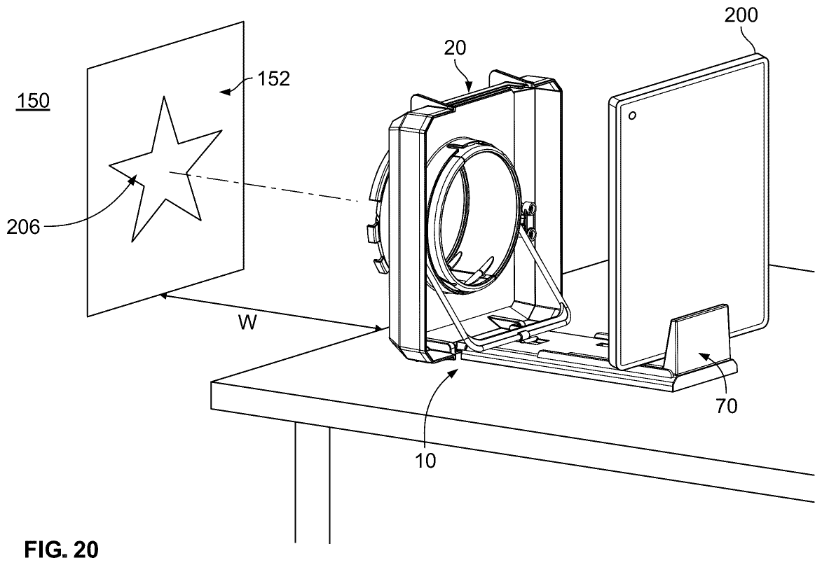

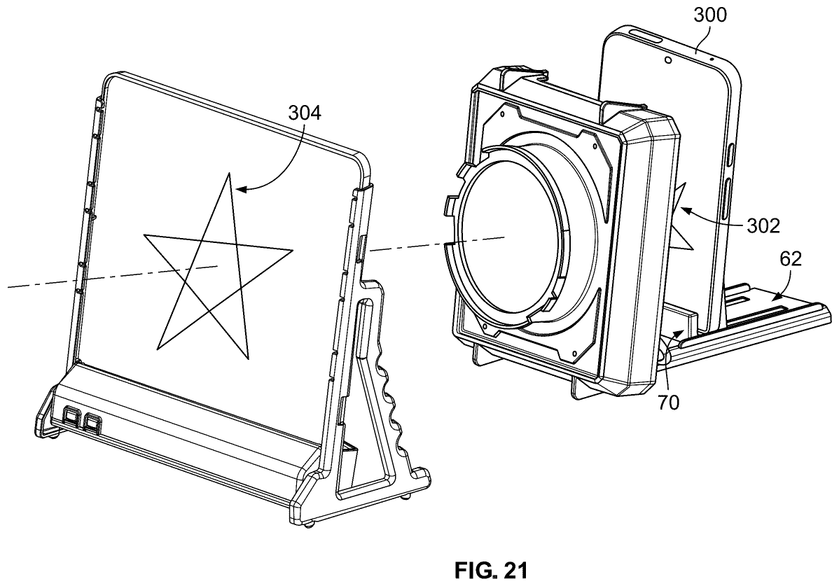

An adjustable device projection system in accordance with one exemplary aspect of the invention described and claimed herein is identified generally as 10 in FIG. 1. As described in more detail below, the projection system 10 is configured for use with various display devices, including a tablet 200 as shown in FIGS. 17-20 and a mobile phone 300 as shown in FIG. 21, which can be oriented in both portrait and landscape orientations. Additionally, as described in more detail below, the projection system 10 is configured for use with multiple designated display surfaces, including light-transmissive media such as the light board assembly 110 shown generally in FIGS. 17-19 and opaque media such as the wall-mounted drawing sheet 152 shown in FIG. 20. Thus, it will be appreciated that it is within the scope of the invention for the adjustable device projection system 10 to be used with, and alternatively without, the light board assembly 110.

Referring to FIG. 1, the adjustable device projection system 10 broadly includes a main housing 20, a base 60, and a device holder 70. The main housing 20 is configured to hold a lens holder 40 holding a lens 46. As will be described in greater detail below, the lens holder 40 is broadly configured to move relative to the main housing 20 for adjusting a focus of images that are transmitted through the lens 46 during use of the projection system 10. Referring to FIGS. 17-21, the device holder 70 is broadly configured to hold a variety of different display devices in optical alignment with the lens 46 in various device orientations, and the device holder 70 is further configured to travel relative to the base 60 and main housing 20 for adjusting a magnification of images that are transmitted through the lens 46. Thus, both individually and collectively, the lens holder 40 and device holder 70 are configured to adjust images transmitted through the lens 46.

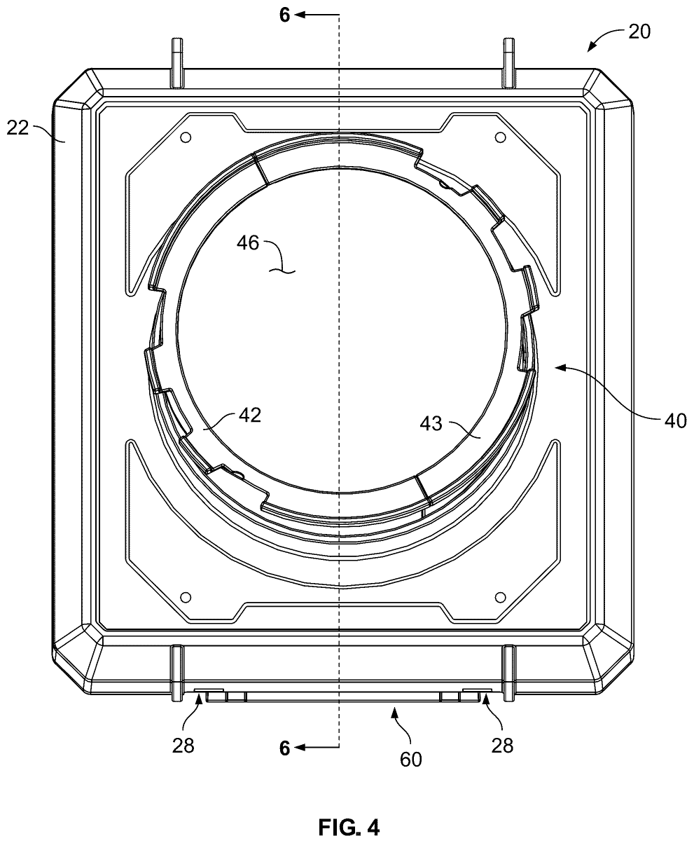

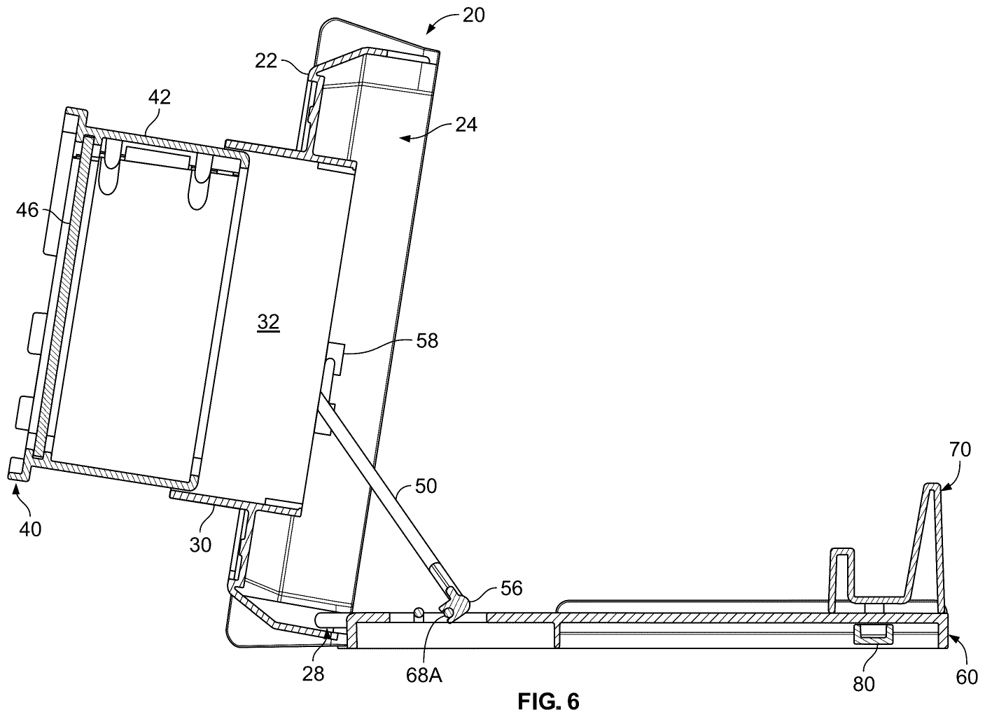

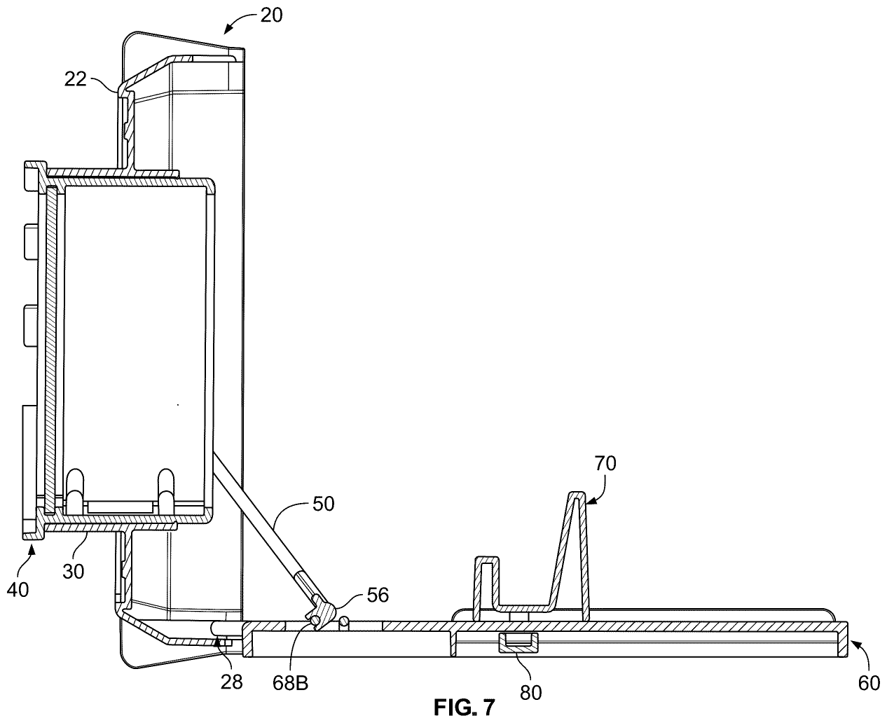

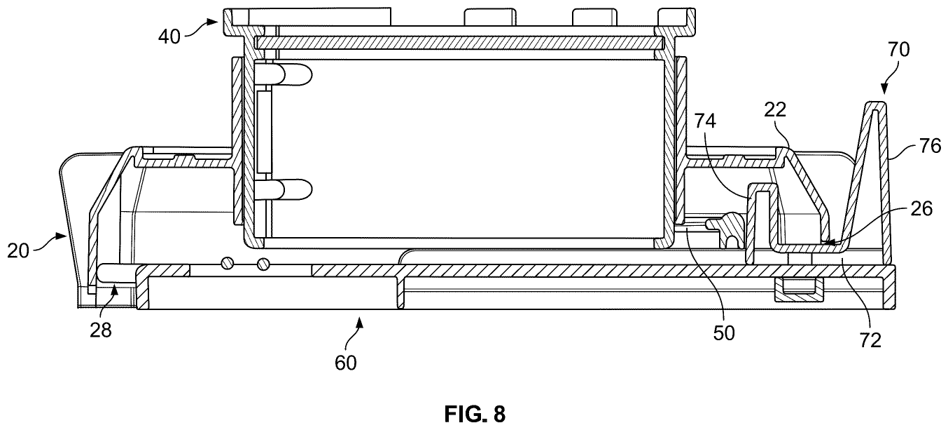

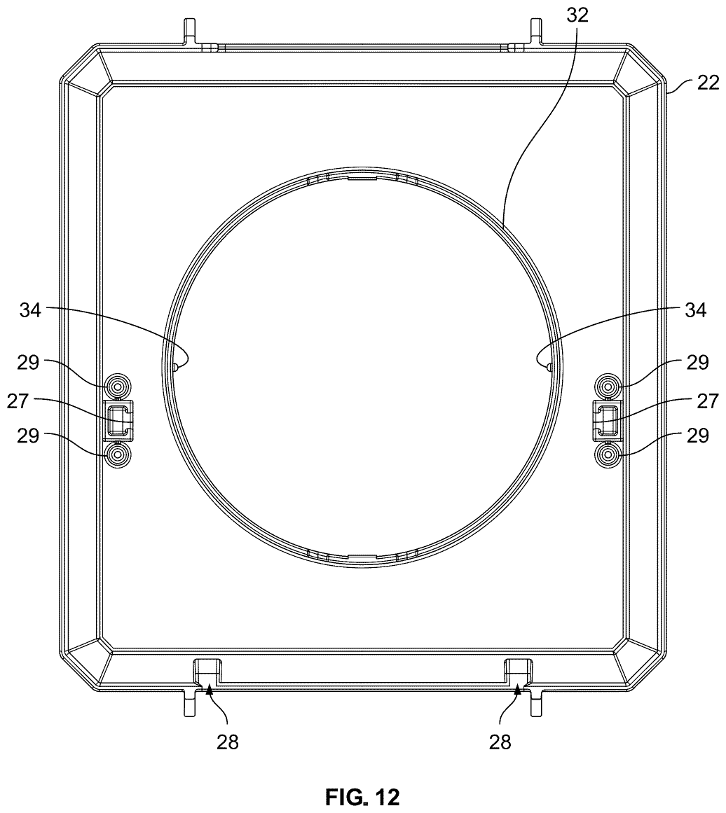

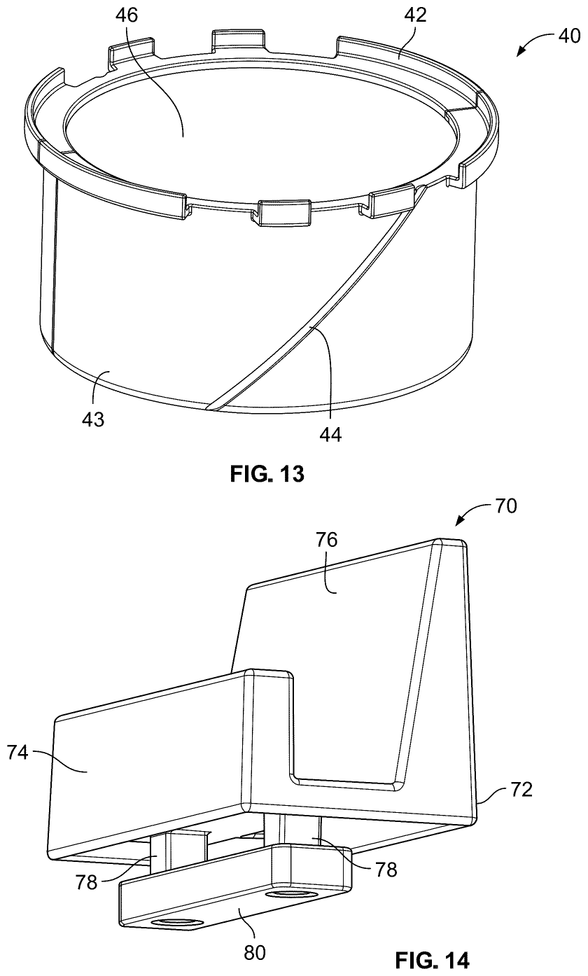

Referring to FIGS. 4-8 and 11-12, the main housing 20 has a main housing body 22 that defines an interior cavity 24 and a lens holder interface 30 which includes a support wall 32 projecting through and extending outward from the main housing body. Referring to FIGS. 1 and 8, the main housing body 22 additionally defines a fitting indentation 26 configured to fit around the base 60 when the projection system 10 is in a collapsed configuration, as described in more detail below, to provide a compact form factor in the collapsed configuration. As illustrated in FIGS. 6-7, the lens holder interface 30 is configured to retain the lens holder 40 in adjustable engagement. In particular, the support wall 32 is configured to fit closely around lens holder body portions 42, 43 (see FIGS. 4, 6), and two follower studs 34 that are integrally formed on diametrically opposite locations on the support wall 32 (see FIGS. 11-12) are configured to engage adjustment grooves 44 formed in each lens housing body portions to constrain the motion of the lens holder 40 relative to the main housing body 22 (see FIG. 13). In an exemplary embodiment, the main housing body 22 and lens holder body portions 42, 43 may be formed from a polymeric material, e.g., molded plastic. As discussed in more detail below, the lens holder 40 is configured to be rotated relative to the lens holder interface 30 to drive inward and outward motion relative to the main housing body 22 as the follower studs 34 and adjustment grooves 44 engage. The relative motion of the lens holder 40 allows users to adjust the focus of images transmitted through the lens 46 (as generally illustrated in FIGS. 6-7). It is contemplated the lens holder 40 can travel along a focal axis F passing through the center of the lens 46 (FIG. 17) up to 50 mm when the lens holder is rotated along the full range of motion of the grooves 44, and rotates approximately 60 degrees about the focal axis. In this manner, the lens holder 40 can be adjusted between a retracted configuration and an extended configuration with respect to the main housing body 22. In alternative embodiments, other varieties of adjustment mechanisms can be used to adjust the focal position of the lens holder 40 relative to the main housing body 22, such as threads, rack-and-pinion mechanisms, adjustment screws, quick release pins, and other similar features. The lens holder body portions 42, 43 define an aperture having a diameter of approximately 100 mm.

Referring now to FIG. 13, the lens holder 40 includes two lens holder body portions 42, 43 which can be fastened together to contain the lens 46 as shown in FIGS. 4, 6. The lens holder 40 can be readily inserted into the lens holder interface 30 for use in the projector system 10, including for the rotational adjustment discussed above in connection with the follower studs 34 and adjustment grooves 44. The lens 46 is made of a light-transmissive material such as glass or polycarbonate and has a diameter of approximately 100 mm, though it is contemplated that lenses of other materials and dimensions can be used without departing from the scope of the invention.

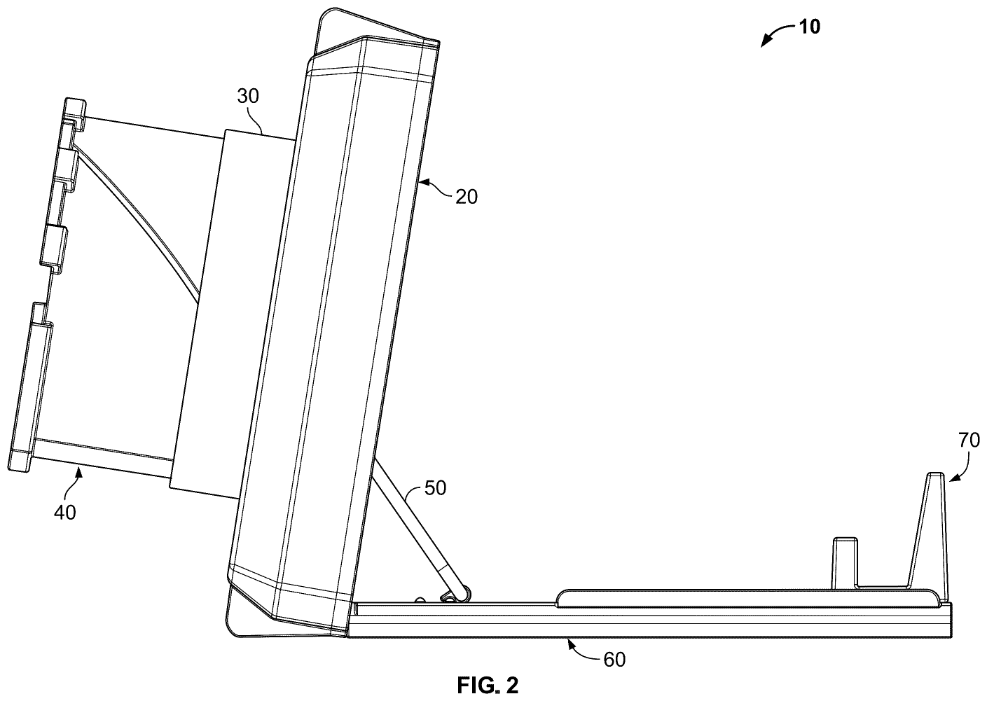

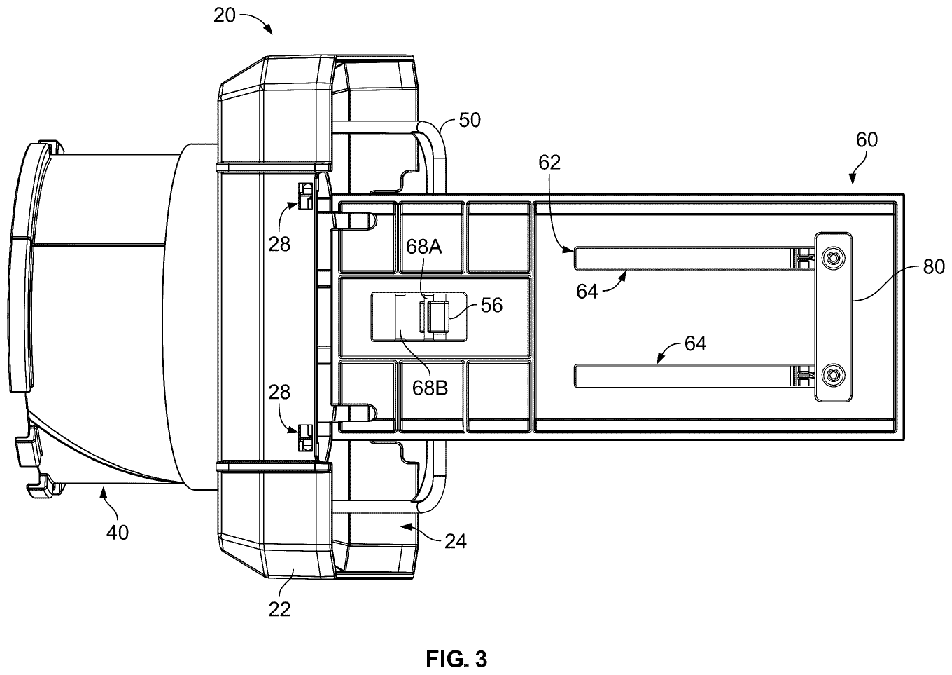

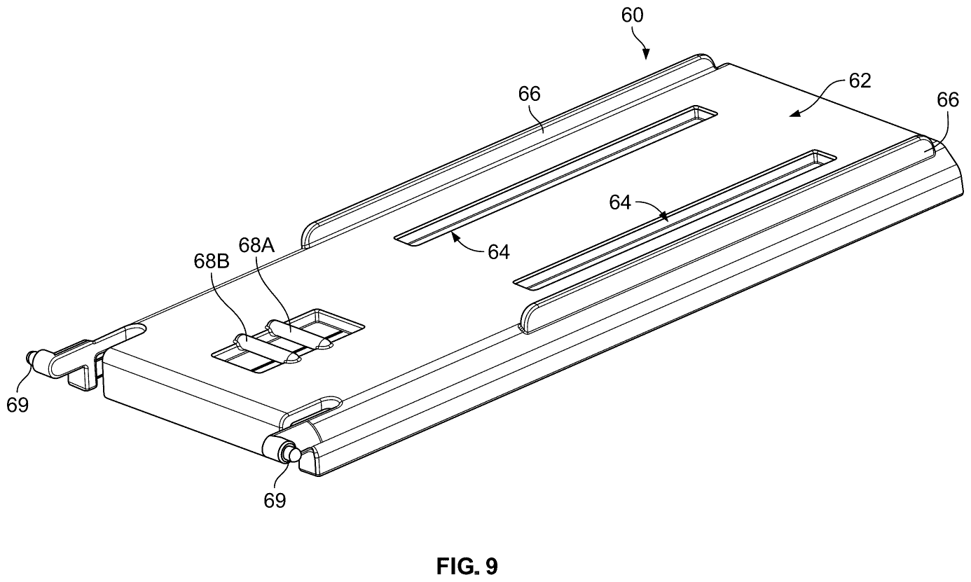

Referring now to FIGS. 3-9 and 11-12, the main housing 20 is pivotably connected to the base 60, which allows the projector system 10 to be positioned in multiple different configurations, including in a light board projection orientation in which the main housing is angled approximately 80 degrees relative to the base for alignment with the light board assembly 110 discussed below (FIGS. 1-6, 17-19, 21), a wall projection orientation in which the main housing is substantially vertical relative to the base and images are projected substantially horizontally (FIGS. 7, 20), and a collapsed orientation (FIG. 8) to provide a smaller form factor for storage and/or transport. As shown in FIG. 9, the base 60 includes two pivot joints 69 which are configured to mate with hinge receptacles 28 formed in the main housing body 22 (FIGS. 11-12). The pivotable connection between the main housing 20 and base 60 can be supplemented with locking or clasping mechanisms, such as the main housing support 50 described in more detail below, to hold the main housing in one or more designated orientations relative to the base. The pivotable connection between the main housing 20 and base 60 can additionally be supplemented with biasing mechanisms, for example a bias spring configured to urge the main housing toward the base in the collapsed orientation.

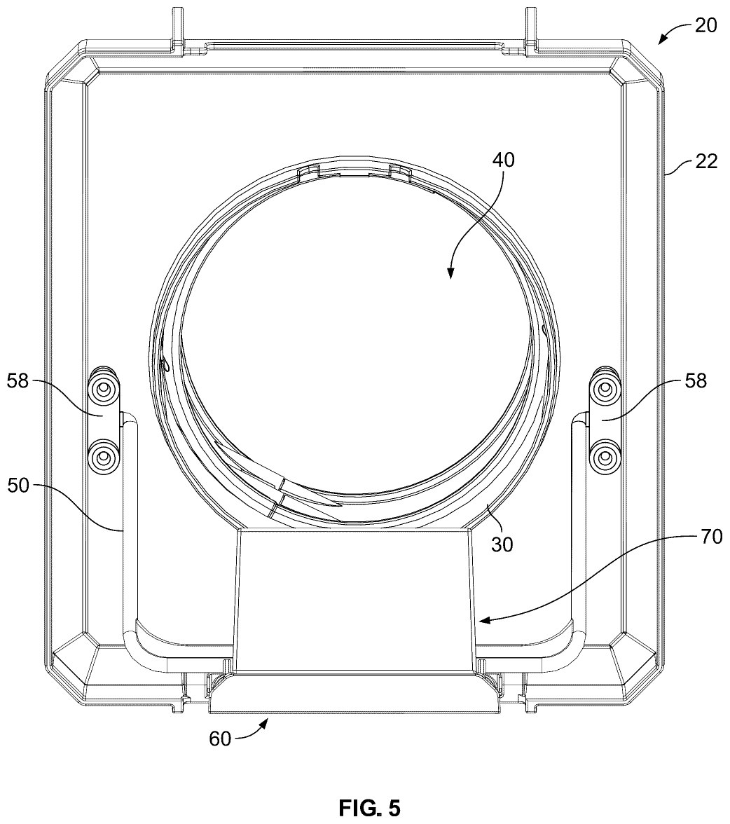

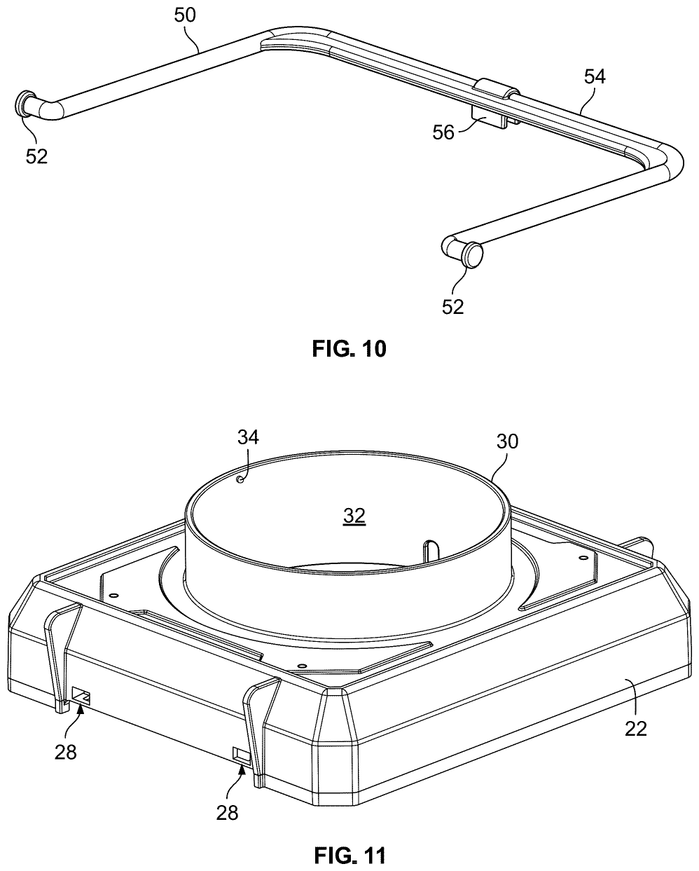

Referring further to FIGS. 5-8, 10, and 12, the main housing 20 is connected to a main housing support 50 which engages with the base 60 to secure the main housing in the light board projection orientation and the wall projection orientation discussed above. Thus, among other functions, the main housing support 50 acts as a support configured to adjust the focal axis of the projection system 10. As shown in FIG. 10, the main housing support 50 has a U-shaped crossbar structure. The main housing support 50 broadly includes a support arm 54 and two pivot ends 52 located outward from the support arm. A clip 56 is affixed to the support arm 54 and, as illustrated in FIGS. 6-7, the clip is configured to selectively engage the props 68A, 68B located in the base 60 (FIG. 9) so the main housing 20 can be supported by the main housing support 50 in the respective light board projection orientation (when engaged with prop 68A) and wall projection orientation (when engaged with prop 68B), as discussed above. The pivot ends 52 are configured to engage sockets 27 formed in the main housing body (FIG. 12), which are covered by mounting brackets 58 (FIGS. 5, 6) fastened to receptacles 29 formed in the main housing body (FIG. 12) so that the main housing support 50 can be pivotably adjusted to multiple angles, including angles for engagement with the props 68A and 68B (FIGS. 6-7) and, as shown in FIG. 8, for being folded in a compact position within interior cavity 24 when the main housing 20 is in the collapsed orientation discussed above. It is contemplated that other locking or adjustment mechanisms, such as quick release pins or friction hinges, can be used in addition to or instead of the housing support 50 to adjustably secure the main housing 20 to the base 60.

Referring again to FIG. 9, the base 60 additionally includes a track 62 that is configured to align the device holder 70 with the lens 46 so that images displayed on the display devices held on the device holder (e.g., the inverted display image 202 displayed on the tablet 200 of FIG. 17) can be transmitted through the lens along a focal axis F to be projected on a designated drawing surface (e.g., the upright tracing image 204 displayed on the drawing surface 118 of FIG. 17). The track 62 is broadly defined by two parallel slots 64 that extend longitudinally from a first side of the track to a second side of the track to define a range of motion of the device holder 70 relative to the lens 46. As shown in FIGS. 6-7, 17, and 21, the track 62 allows the device holder 70 to travel forward and backward along the focal axis F relative to the lens 46 to alter a focal distance associated with the lens for image magnification. As shown in FIG. 9, in the illustrated embodiment, the slots 64 are at least 80 mm long and are configured to extend fully through a thickness of the base 60 so that the posts 78 located beneath the body 72 of device holder 70 (FIG. 14) can be inserted through the slots and can be fastened to the device holder mount 80 (see FIG. 3) to constrain the motion of the device holder 70 to substantially one-dimensional travel along the track 62 in generally forward and backward directions relative to the focal axis F. Additionally, two side guards 66 extend upward from the base 60 to provide additional alignment and stability for the device holder 70. In this manner, it is contemplated that the device holder 70 is slidable on the track 62 between at least a first position at a first end of the track that is a maximum distance away from the lens 46 (FIG. 6) and a second position at a second end of the track that is a minimum distance away from the lens (FIG. 7). In alternative embodiments, it is contemplated that other adjustment mechanisms can be used instead of or in addition to the track 62, with non-limiting examples of alternative adjustment mechanisms including rails, biasing or ratcheting mechanisms, or rack and pinion mechanisms.

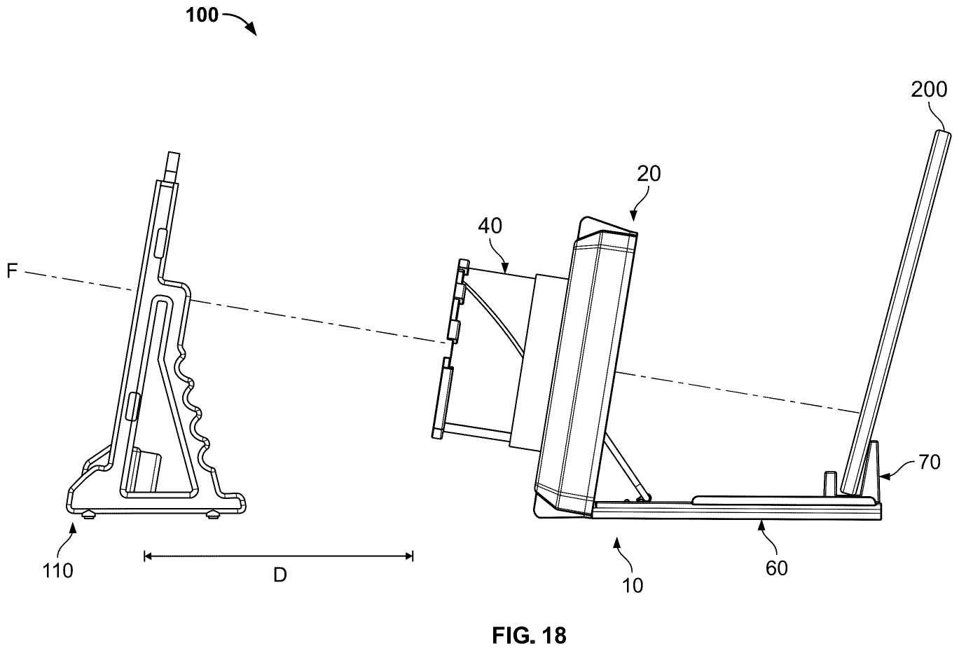

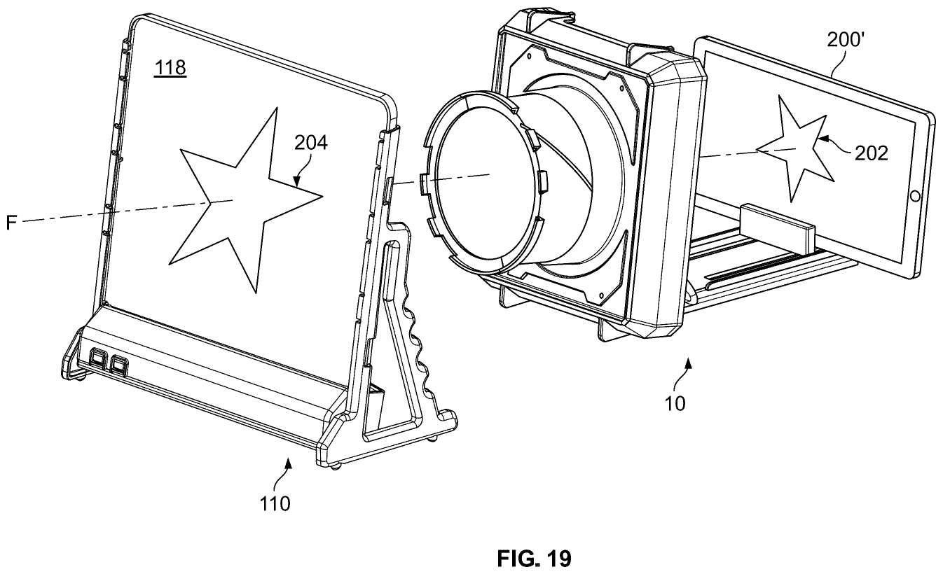

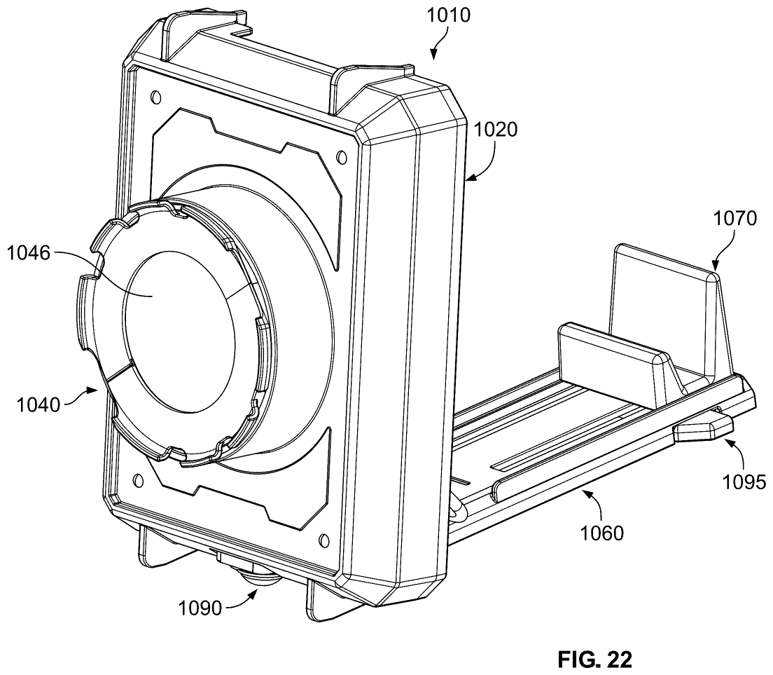

Referring now to FIG. 14, the device holder 70 broadly comprises a device holder body 72 that includes a front guard 74, a rear support 76, and two posts 78. The front guard 74 and the rear support 76 are oriented generally upward with respect to the body 72. As is generally illustrated in FIGS. 18-19 and 21, the device holder 70 is broadly configured to support a variety of different display devices in one or more orientations (e.g., a portrait mode and a landscape mode). Additionally, the device holder 70, and more specifically the rear support 76, is configured to support display devices generally in optical alignment with the lens 46. For example, as seen in FIG. 18, when the projection system 10 is used with a tablet 200, the tablet sits in the device holder 70 at an angle that is approximately parallel to the orientation of the lens when the main housing 20 is in the light board projection orientation discussed above. The front guard 74 is spaced horizontally apart from the rear support 76 at a sufficient distance to permit devices of different thicknesses to be supported by the device holder 70. The front guard 74 provides an upright barrier that prevents devices from sliding forward substantially, e.g., due to gravity or being bumped. Additionally, it is contemplated that the body 72 has a width sufficient to provide substantial lateral stability for devices placed on the device holder 70, most especially devices that are balanced. As illustrated in the alternative embodiment shown in FIG. 22, it is contemplated that device holders of differing widths (such as device holder 1070) can also be used without departing from the scope of the invention.

Referring additionally to FIG. 8, the device holder 70 is configured to fit in close conformity with the main housing body 22 when the main housing 20 is positioned in the collapsed orientation. In particular, the device holder 70 is configured to rest at the back end of the track 62 with the front guard 74 fitting inside the cavity 24, the fitting indentation 26 (FIG. 1) conforming closely around a middle portion of the device holder body 72, and the rear support 76 remaining generally outside of the main housing body 22. When the main housing 20 is in the collapsed orientation, the range of motion of the device holder 70 is substantially limited to avoid unwanted movement in situations where the projection system 10 is in storage or is being carried.

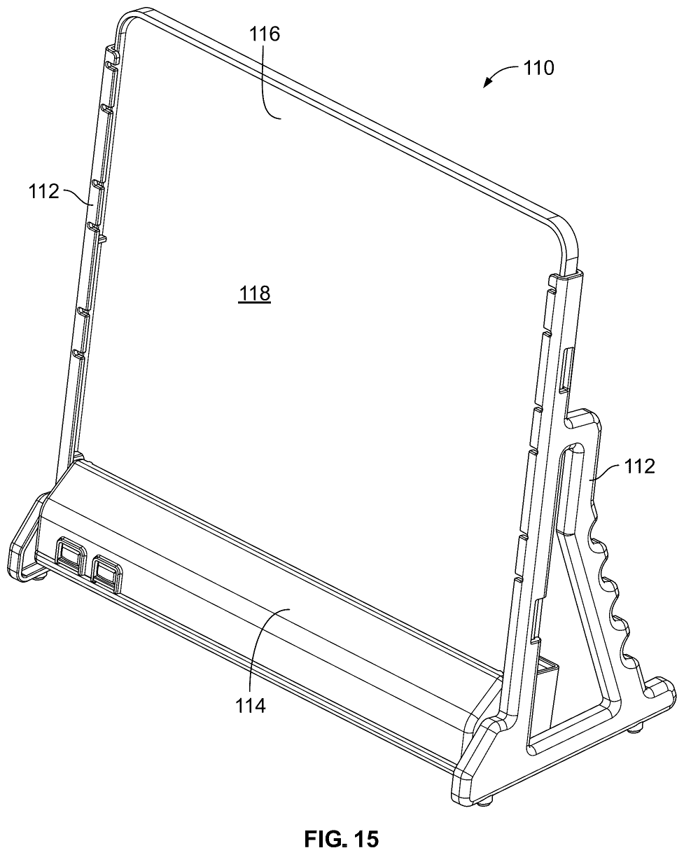

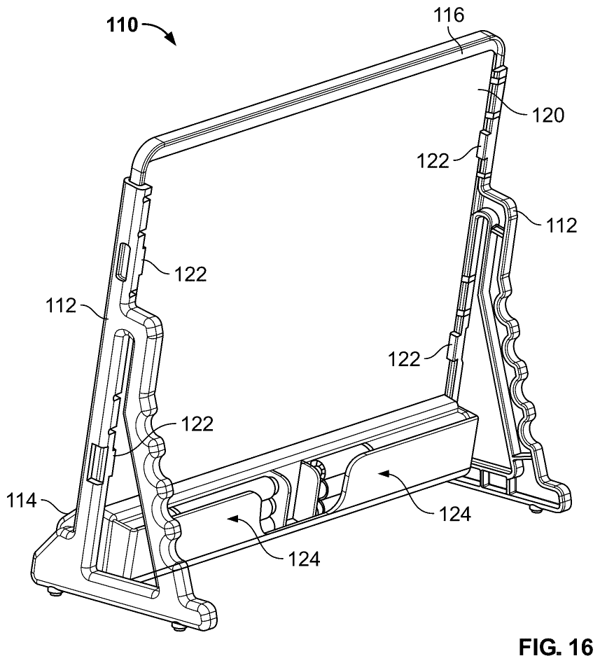

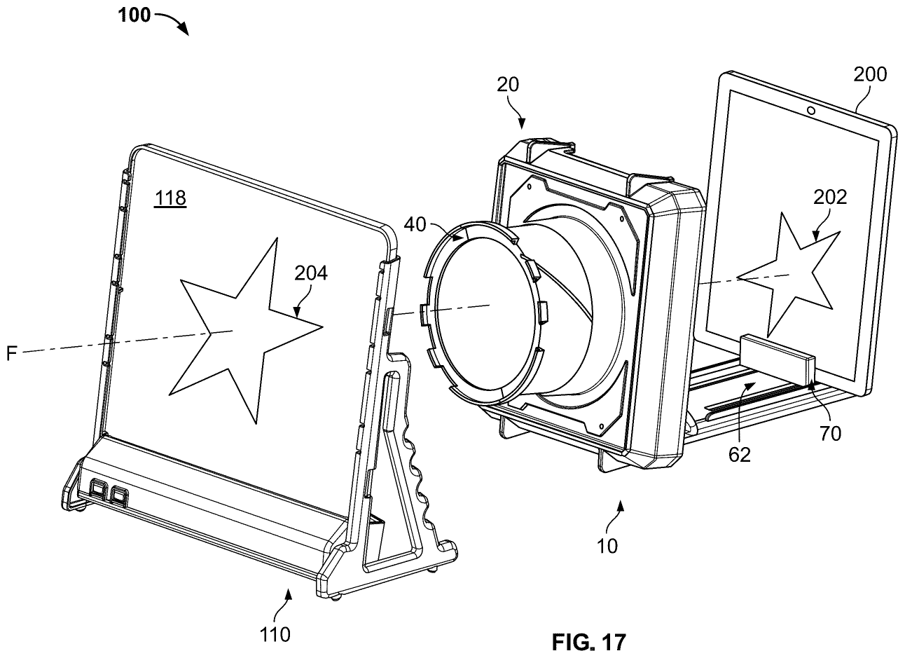

As shown in FIGS. 17-18, the projection system 10 is provided in a device projection and tracing kit 100 that additionally includes a light board assembly 110 (more generally, a light board system) configured to display images projected by the projection system so a user can trace or draw over the displayed images using drawing tools such as markers. In particular, referring to FIGS. 15-16, the light board assembly 110 includes a drawing pane 116 with a drawing surface 118, a frost sheet 120 located adjacent the drawing pane opposite the tracing surface, and a backlight apparatus 114 positioned beneath the drawing pane and frost sheet. Two supports 112 are configured to securely hold the backlight apparatus 114, the drawing pane 116, and the frost sheet 120 in a position suitable for displaying the images projected from the projection system 10 and for tracing and/or drawing on the drawing surface 118. Referring specifically to FIG. 16, the supports 112 include tabs 122 which secure the frost sheet 120 in close contact with the drawing pane 116 so a substantially uniform image can be transmitted through the drawing pane 116. It will be appreciated that the frost sheet 120 is made of a diffusive material, such as vellum paper or a polymeric material with one or more textured surfaces. The backlight apparatus 114 is configured to illuminate a region defined by the drawing pane 116 and frost sheet 120 to manipulate the visibility of the images projected by the projection system relative to drawings drawn on the drawing surface 118. As shown in FIG. 16, in the illustrated embodiment, the light board assembly 110 includes storage compartments 124 coupled to the body of the backlight apparatus 114, which provide convenient access to objects such as drawing tools for use with the light board assembly. The backlight apparatus 114 may provide a relatively constant light signal for the light board assembly 110 or may pulse in a flashing pattern that periodically emphasizes and de-emphasizes the images projected from the projection system 10. For example, the backlight apparatus 114 may be configured to provide a light signal that pulses on and off every two seconds. The alternating flashing pattern may assist users with visualizing images drawn or traced on the drawing surface 118 in direct comparison to the images projected from the projection system 10.

The projection system 10 can also be used without the light board assembly 110. For example, referring now to FIG. 20, the projection system 10 can project images onto a surface such as a wall. In FIG. 20, the projection system 10 is shown holding the tablet 200 and projecting an image therefrom to a drawing sheet 152 mounted on a wall surface 150. It will be appreciated that, due to the scale of magnification in this embodiment, environmental light around the projection system 10 should be minimized to ensure adequate visibility of the images being projected.

Now with reference to FIGS. 17-18, a method of using the kit 100 with the projection system 10, the light board assembly 110, and the tablet 200 will be described. To set up the kit 100, a user positions the main housing 20 in the light board projection orientation by engaging the clip 56 with the prop 68A. Then, the user slides the device holder 70 back in the track 62 in a position farthest away from the main housing 20. Additionally, the user adjusts the position of the lens holder 40 to be in its outward-most position relative to the main housing 20 (e.g., by rotating the lens housing and causing travel of the grooves 44 along the follower studs 34). After the projection system 10 has been thus configured, the user places the projection system and the light board assembly 110 on an even surface such as a table or desk (not shown) so the projection system and light board assembly 110 are generally aligned along focal axis F. As shown in FIG. 18, it is contemplated that the projection system 10 and light board assembly 110 are initially spaced apart a nominal distance D of approximately 30 cm, which can be further adjusted for image magnification and clarity once the display image 202 is projected through the projection system 10.

Next, the user selects a display image 202 to display on the screen of tablet 200, which will be projected onto the light board assembly 110. It is contemplated that the display image 202 can either be a drawing with clearly defined lines for direct tracing or a standard image for more free-form drawing. As is best seen in FIG. 17, it will be appreciated that the display image 202 shown on the tablet 200 is inverted relative to the tracing image 204 that will be displayed on the light board assembly 110. As best seen in FIG. 17, the user can orient the display image 202 on the display of the tablet 200 to be generally centered on the focal axis F so that the tracing image 204 remains centered relative to the drawing pane 116. The user may adjust settings of the tablet 200 to ensure the display image 202 remains on-screen and remains sufficiently bright for long periods of time, for example, by disabling a screen off timer and/or adaptive brightness settings. Likewise, the user may adjust settings to ensure the display image 202 does not change in orientation after the tablet 200 is placed in the device holder 70, for example, by disabling an auto-rotate setting.

After the display image 202 is set for display on the tablet 200, the user places the tablet 200 on the device holder 70 between the front guard 74 and rear support 76. The display image 202 is directed generally toward the lens holder 40 and the light board assembly 110 for projection. This causes tracing image 204 to appear on the light board assembly 110 via frost sheet 120. Depending on the magnification and focus of the tracing image 204, the user can adjust the magnification and clarity of the projected image by adjusting one or more of: the nominal distance D between the projection system 10 and light board assembly 110, the angle and position of the lens holder 40 relative to the main housing 20, or the horizontal position of the device holder 70 in the track 62. After the kit 100 is adjusted to the user's satisfaction, the user can draw or trace on the light board drawing surface 118 using the tracing image 204 for guidance. It is contemplated that the user can activate the backlight apparatus 114 as an assistive tool for selectively illuminating the light board assembly 110 as discussed above. When finished, the user may detach the clip 56 from the prop 68A and collapse the projection system 10 as generally shown in FIG. 8.

Referring now to FIG. 19, a method of using the kit 100 with the tablet 200 in a landscape orientation (as indicated by reference number 200′) involves substantially the same steps as described above in connection with using the tablet 200 in a portrait orientation, except that the user orients the tablet display image 202 in an orientation that corresponds to the desired orientation of the tablet when placed on the device holder 70 (i.e., approximately 90 degrees in either direction). As above, it will be appreciated that the tablet display image 202 is inverted relative to the tracing image 204.

Referring now to FIG. 20, an alternative method of using the projection system 10 broadly involves projecting images from a display device onto a drawing surface on a wall. In particular, the wall 150 includes a drawing sheet 152 which is aligned with the projection system 10 so a tracing image 206 can be cast on the drawing sheet from an inverted image displayed on tablet 200 (not shown). It is contemplated the drawing sheet 152 has dimensions of approximately 40 cm×40 cm and is spaced apart from the projection system 10 a nominal wall distance W of between 90 cm and 120 cm. The steps of setting up the projection system 10 are similar to the steps described above in connection with setting up the projection system for use with the kit 100. However, in contrast to the above-described setup, the user engages the clip 56 with the prop 68B so the main housing 20 is set up in the wall projection orientation. Additionally, the user orients the lens holder 40 in its most inward position relative to the main housing 20 during setup and adjusts the focus of the lens 46 by generally rotating the lens assembly in the opposite direction as above. In further embodiments, users can use the projection system 10 to project still or moving images onto a wall or similar surface without tracing or drawing thereon.

Referring now to FIG. 21, it is contemplated that the method discussed above in connection with FIGS. 17-19 can be adjusted by replacing the tablet 200 with a mobile phone 300 that has a substantially smaller display (e.g., no more than half the screen area of the tablet). The setup process for this alternative method is substantially the same as the above-discussed steps for setting up the kit 100 with the tablet 200, though it will be appreciated that the display image 302 may be smaller than a corresponding display from the tablet 200, and thus demands more magnification, but is otherwise substantially similar. Thus, in order to produce a tracing image 304 that substantially fits the entire drawing surface 118 of light board assembly 110, the user may need to move the device holder 70 and mobile phone 300 inward toward the main housing 20 a greater distance than would be required with a tablet to achieve the same image size.

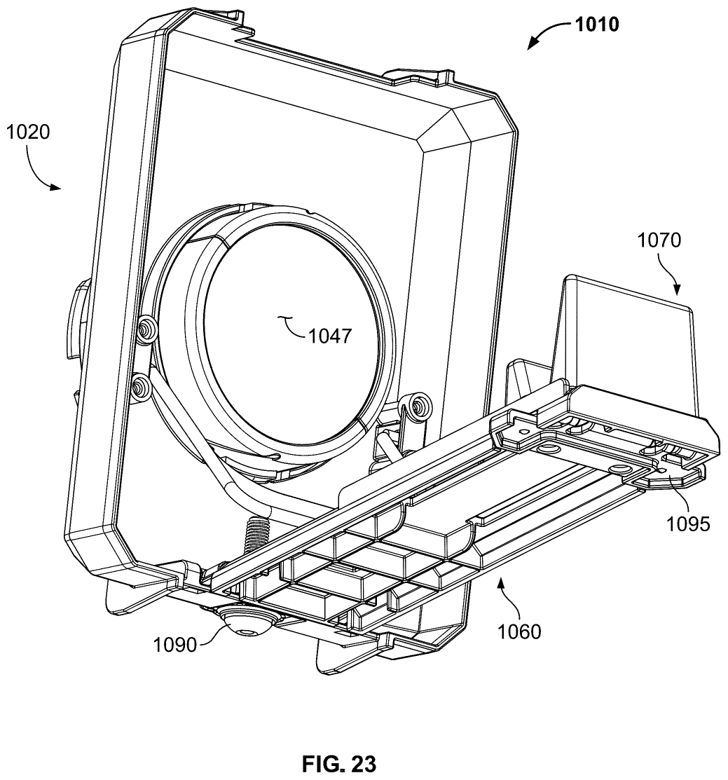

An adjustable device projection system in accordance with another exemplary aspect of the invention described and claimed herein is identified generally as 1010 in FIGS. 22-24. The projection system 1010 broadly includes similar components to the projection system 10 described in detail above, including a main housing 1020, a lens holder 1040, a base 1060, and a device holder 1070. The projection system 1010 additionally includes two height-adjusting elements: an adjustable foot 1090 (broadly, a post) located beneath the main housing 1020, and a pivoting stand 1095 located beneath the base 1060 on an opposite end of the system. Further details regarding the height-adjusting elements will be described below. In this embodiment, the lens holder 1040 additionally includes a first lens 1046 (FIG. 22) and a second lens 1047 (FIG. 23), which are located on generally opposite sides of the lens holder.

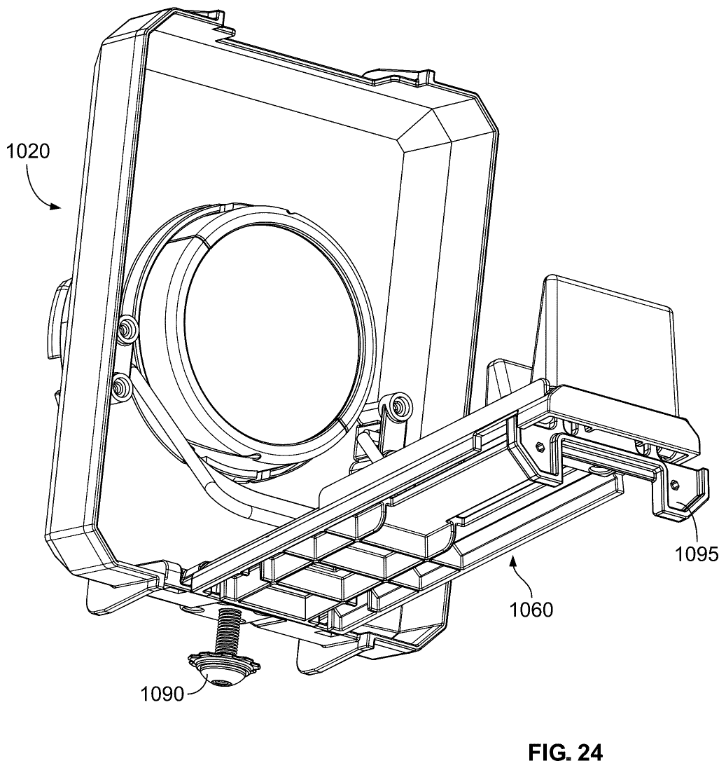

The foot 1090 and stand 1095 are configured to adjust the relative heights of the main housing 1020 and device holder 1070, for example, to adjust the vertical centering of projected images or to direct projected images to a higher or lower point relative to a default position. In the illustrated embodiment, the foot 1090 is an adjustment screw with a head configured to contact a surface on which the projection system 1010 can be placed. By adjusting the position of the foot 1090, a user can relatively precisely adjust the elevation of the main housing 1020. The stand 1095 is configured as a hinged leg that is pivotably coupled to the base 1060. The stand 1095 can pivot between a compact, stowed orientation, as shown in FIG. 23, in which the stand is tucked under and is generally flush with the base 1060 and an extended orientation, as shown in FIG. 24, in which the leg protrudes downward from the base 1060 to elevate the device holder 1070 a fixed distance. In this manner, the stand 1095 can be used as a support to adjust an orientation of the projection system 1010 and the angle of a focal axis thereof in an analogous manner to the selective engagement of the clip 56 of main housing support 50 with the props 68A and 68B, as discussed above in connection with the projection system 10 shown FIGS. 6-7. Thus, it will be appreciated that the stand 1095 can function as a type of support for adjusting an orientation of a focal axis of the projection system 1010. Additionally, it will be appreciated that the foot 1090 in front is configured for continuous and precise height adjustment while the stand 1095 in the rear provides only two settings, thus allowing users to make fine adjustments to the projection system 1010 between the orientations defined by stowing and extending the stand on its own. It is contemplated that other height-adjusting mechanisms can be used without departing from the scope of the invention.

From the foregoing examples, it will be appreciated that the adjustable device projection systems described herein include multiple structures suitable for adjusting different aspects of operation, including focus, magnification, orientation, and elevation. Although the embodiments described herein include specific combinations of these features, it should be understood that, in alternative embodiments, projection systems having other combinations of one or more of these features are also contemplated as embodying aspects of the invention described herein.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. An adjustable device projection system comprising:
a main housing comprising at least one lens defining a focal axis;
a base coupled to and extending from the main housing;
a device holder coupled to the base, the device holder configured to hold at least one of a mobile phone or a tablet generally in optical alignment with the at least one lens; and
an adjuster comprising at least one of:
a track extending along the base, wherein the device holder slidably engages the track such that a position of the device holder is adjustable relative to the at least one lens in a direction generally aligned with the focal axis; or
a support configured to adjust an orientation of the focal axis.

2. The adjustable device projection system of claim 1, wherein the main housing comprises a main housing body and a lens holder, wherein the at least one lens is held by the lens holder, and wherein the lens holder is adjustable between a retracted configuration and an extended configuration relative to the main housing body.

3. The adjustable device projection system of claim 1, wherein the device holder is slidable on the track between at least a first position and a second position, wherein the device holder is closer to the at least one lens in the second position than in the first position.

4. The adjustable device projection system of claim 1, wherein the base is pivotably coupled to the main housing, and wherein the main housing is movable relative to the base between a plurality of designated projection orientations.

5. The adjustable device projection system of claim 4, wherein the plurality of designated projection orientations comprises a substantially horizontal projection orientation in which the main housing is substantially perpendicular to the base and an intermediate projection orientation in which there is an acute angle between the main housing and the base.

6. The adjustable device projection system of claim 4, wherein the support comprises a main housing support adapted for selectively supporting the main housing in the plurality of designated projection orientations.

7. The adjustable device projection system of claim 6, wherein the main housing support is configured to collapse relative to the main housing when the main housing is placed in a collapsed orientation relative to the base.

8. The adjustable device projection system of claim 1, wherein the support comprises a stand coupled to the base, the stand being movable between at least a first position, in which the base is oriented at a first angle relative to a support surface on which the base is placed, and a second position, in which the base is oriented at a second angle relative to the support surface, the second angle being greater than the first angle.

9. The adjustable device projection system of claim 1, wherein the adjuster comprises both the track and the support.

10. The adjustable device projection system of claim 1, wherein the device holder is configured to hold a mobile phone and a tablet, and wherein the tablet has a tablet display screen with a surface area at least twice the size of a surface area of a phone display screen of the mobile phone.

11. The adjustable device projection system of claim 10, wherein the device holder is configured to hold both the mobile phone and the tablet in a substantially vertical display orientation and a substantially horizontal display orientation.

12. The adjustable device projection system of claim 1, wherein the main housing further comprises an adjustable post configured to manipulate an elevation of the at least one lens relative to a support surface on which the base is placed.

13. A tracing kit for mobile devices comprising the device projection system of claim 1 and a light board system adapted for displaying an image generated by a display of a device held by the holder;
wherein the light board system comprises a light-transmissive drawing surface through which the image can be transmitted; and
wherein the light board system and the device projection system can be positioned independently relative to each other to manipulate the image projected to the light board system by the device projection system.

14. An adjustable device projection system comprising:
a main housing comprising at least one lens defining a focal axis and a lens holder configured to hold the at least one lens; and
a base coupled to the main housing, the base comprising a device holder configured to hold at least one of a mobile phone or a tablet such that a display of the at least one of a mobile phone or a tablet is generally optically aligned with the at least one lens,
wherein the device holder is configured to be selectively positioned on the base relative to the at least one lens in a direction generally aligned with the focal axis, and wherein the lens holder is configured to be adjustably positioned within the main housing to selectively adjust a focus of the at least one lens when an image is transmitted from the display of the device held by the device holder.

15. The adjustable device projection system of claim 14, wherein the device holder and the lens holder are configured to be independently adjusted.

16. The adjustable device projection system of claim 14, wherein the main housing is pivotably coupled to the base, and wherein the main housing is movable relative to the base between a collapsed orientation and at least one designated projection orientation for projecting the image transmitted from the display of the device held by the device holder.

17. A tracing kit for mobile devices comprising a device projection system and a light board system, the device projection system comprising at least one lens and a device holder;
wherein the device holder is configured to hold at least one of a mobile phone or a tablet generally in optical alignment with the at least one lens;
wherein the device projection system is configured to transmit an image generated by a display of a device held by the holder through the at least one lens; and
wherein the light board system comprises a light-transmissive drawing surface through which an image from the device projection system can be transmitted.

18. The tracing kit of claim 17, wherein the light board system and the device projection system can be positioned independently relative to each other to manipulate the image projected to the light board system from the device projection system.

19. The tracing kit of claim 17, wherein the device projection system holds the at least one lens in a selectively adjustable configuration so that a focus of the at least one lens can be selectively adjusted.

20. The tracing kit of claim 17, wherein the light board system comprises a diffusive panel positioned between the drawing surface and the at least one lens, and wherein the light board system further comprises a backlight configured to illuminate a region between the drawing surface and the diffusive panel.
